(19) United States
(12) Patent Application Publication
(10) Pub. No.: US 2011/0274038 A1
(43) Pub. Date: Nov. 10, 2011

(54) METHOD AND APPARATUS FOR AVOIDING UNNECESSARY BEARER ESTABLISHMENT IN CIRCUIT SWITCHED FALLBACK

(75) Inventors: Xipeng Zhu, Beijing (CN); Wolfgang Granzow, Heroldsberg (DE)

(73) Assignee: QUALCOMM INCORPORATED, San Diego, CA (US)

(21) Appl. No.: 12/941,659

(22) Filed: Nov. 8, 2010

Related U.S. Application Data
(60) Provisional application No. 61/259,578, filed on Nov. 9, 2009.

(51) Int. Cl. H04W 4/00

(52) U.S. Cl. 370/328

(57) ABSTRACT

Methods and apparatuses are provided that facilitate avoiding establishment of unnecessary radio bearers in circuit switched fallback (CSFB). A CSFB procedure related to a device can be detected from receiving an extended service request or a forward relocation request, or from determining that an evolved packet system (EPS) is insufficient to handle a circuit switched voice call, and/or the like. Based at least in part on detecting the CSFB, establishment of radio bearers for inactive EPS bearers can be avoided. Where the device is in idle mode before CSFB, avoiding establishment of radio bearers can include avoiding establishment of all data radio bearers for the device.

### CLAIM OF PRIORITY UNDER 35 U.S.C. §119

The present Application for Patent claims priority to Provisional Application No. 61/259,578 entitled “METHOD AND APPARATUS TO AVOID UNNECESSARY EPS RADIO ACCESS BEARER (E-RAB) ESTABLISHMENT IN CIRCUIT SWITCHED FALL BACK (CSFB) SYSTEMS,” filed Nov. 9, 2009, and assigned to the assignee hereof and hereby expressly incorporated by reference herein.

### BACKGROUND

1. Field

The following description relates generally to wireless communications, and more particularly to circuit switched fallback.

2. Background

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), evolution data optimized (EV-DO), etc.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth. In addition, mobile devices can communicate with other mobile devices (and/or base stations with other base stations) in peer-to-peer wireless network configurations.

In addition, mobile devices can communicate with one or more base stations using a packet-switched (PS) technology, such as LTE, which can support voice calls on the mobile device using voice over internet protocol (VoIP). When such technologies are not supported, the device can be directed to a different radio access technology (RAT) that supports circuit switched (CS) services (referred to as circuit switched fallback (CSFB)) to support initiating and/or receiving CS services (e.g. voice calls). CSFB includes a radio resource control (RRC)-release with redirection based fallback, a packet-switching handover based fallback, a cell change order (CCO) with optional network assisted cell change (CCO/NACC) based fallback, and/or the like. In any case, a mobile device initiates CSFB by sending an extended service request (ESR) to a related mobility management entity (MME). In response, the MME establishes data radio bearers at a serving evolved Node B (eNB) for the mobile device. Subsequently, mobile device communications can be directed to the circuit switched service capable RAT, which can include transferring the established radio bearers thereto to continue communications over the related PS bearers.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more embodiments and corresponding disclosure thereof, various aspects are described in connection with avoiding unnecessary bearer establishment in circuit switched fallback (CSFB). For example, in some cases a device may not need data radio bearers (DRB) established for all packet switched (PS) bearers when falling back to circuit switched (CS) capable network. In one example, the device can be in idle mode camping on a PS network. In idle mode, the device can have no active PS services. The device can initiate or otherwise receive a voice call, where the PS network cannot handle the call. In this regard, the device can perform CSFB to a CS capable network, and establishment of DRB(s) can be avoided during CSFB, since the device is establishing service to handle the CS call and does not necessarily need to activate one or more PS bearers (e.g., a bearer for receiving Internet data, video streaming, etc). Avoiding establishment of unnecessary bearers during CSFB can reduce processing time at the device in performing CSFB, as well as save radio resources typically utilized to establish DRB for the PS bearers to be handled by the CS capable network.

According to an example, a method of wireless communication is provided that includes determining a circuit switched fallback (CSFB) procedure related to a device and avoiding establishing one or more radio bearers between a base station and a device during the CSFB procedure.

In another aspect, an apparatus for performing CSFB is provided that includes at least one processor configured to detect a CSFB procedure related to a device and determine to avoid establishment of one or more radio bearers between a base station and a device during the CSFB procedure. In addition, the wireless communications apparatus includes a memory coupled to the at least one processor.

In yet another aspect, an apparatus for performing CSFB is provided that includes means for determining a CSFB procedure related to a device. The apparatus further includes means for avoiding establishing one or more radio bearers between a base station and a device as part of the CSFB procedure.

Still, in another aspect, a computer-program product is provided for performing CSFB including a computer-readable medium having code for causing at least one computer to detect a CSFB procedure related to a device. The computer-readable medium further includes code for causing the at least one computer to determine to avoid establishment of one or more radio bearers between a base station and a device during the CSFB procedure.

Moreover, in an aspect, an apparatus for performing CSFB is provided that includes a CSFB determining component for detecting a CSFB procedure related to a device. The apparatus further includes a bearer setup avoiding component for avoiding establishing one or more radio bearers between a base station and a device as part of the CSFB procedure.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example system for performing circuit switched fallback (CSFB).

FIG. 2 illustrates an example system for avoiding unnecessary radio bearer establishment in CSFB.

FIG. 3 illustrates an example system that causes an evolved Node B (eNB) not to establish at least some radio bearers in CSFB.

FIG. 4 illustrates an example system that causes an evolved packet system (EPS) support node to not request establishment of at least some radio bearers from a circuit switched base station.

FIG. 5 illustrates an example system that performs CSFB.

FIG. 6 illustrates an example system that completes CSFB using packet-switching handover.

FIG. 7 illustrates an example methodology that facilitates avoiding establishment of one or more radio bearers in CSFB.

FIG. 8 illustrates an example methodology that prevents an eNB from setting up one or more radio bearers during CSFB.

FIG. 9 illustrates an example methodology for causing an EPS support node to not request establishment of one or more radio bearers in a circuit switched network.

FIG. 10 illustrates an example methodology that causes a circuit switched network to refrain from establishing one or more radio bearers in CSFB.

FIG. 11 illustrates an example methodology for refraining from transmitting service requests for one or more radio bearers related to a CSFB procedure.

FIG. 12 illustrates an example system for avoiding establishment of one or more radio bearers in CSFB.

FIG. 13 illustrates an example wireless communication system in accordance with various aspects set forth herein.

FIG. 14 illustrates an example wireless network environment that can be employed in conjunction with the various systems and methods described herein.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As described further herein, establishment of one or more data radio bearers (DRB) in a packet switched (PS) network can be avoided during circuit switched (CS) fallback (CSFB) from idle mode. For example, upon receiving an extended service request (ESR) from a device, a mobility management entity (MME) or similar network component can refrain from requesting DRB establishment from an evolved Node B (eNB) for one or more PS bearers related to the device. In another example, the MME can request bearer establishment for the one or more PS bearers, but the eNB can refrain from establishing the one or more DRBs. In either case, the related PS bearers can remain activated in case they are needed at some point following CSFB. In yet another example, regardless of the DRB state at the eNB, the CS capable target network related to CSFB can refrain from establishing DRBs for the one or more PS bearers during the CSFB. In both cases, avoiding establishment of the unnecessary DRBs can save processing time required to establish DRBs during CSFB, as well as resources required to establish and maintain the DRBs.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, evolved Node B (eNB), or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

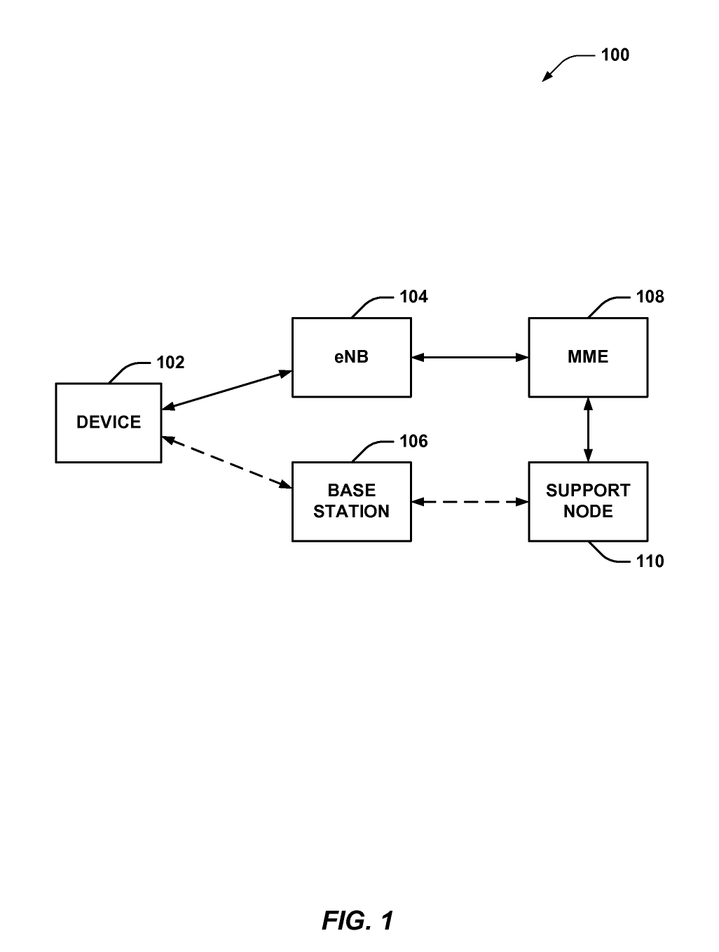

Referring to FIG. 1, illustrated is a wireless communication system 100 that facilitates performing CSFB. System 100 includes a device 102 that can communicate with one or more base stations, such as an eNB 104, a base station 106 of a CS capable target network, and/or the like. For example, device 102 can be a UE, modem (or other tethered device), a portion thereof, or substantially any device that can communicate to one or more base stations or other devices in a wireless network. In addition, eNB 104 can operate according to a PS technology, such as LTE, E-UTRA, etc., and base station 106 can operate according to a CS capable technology, such as UTRA, GSM enhanced data rates for GSM evolution (EDGE) radio access network (GERAN), etc. In this regard eNB 104 can also communicate with a mobility management entity (MME) 108 that can manage communications between device 102 and a core network (not shown).

In addition, system 100 includes a support node 110, which can relate to a general packet radio service (GPRS) network (e.g., a serving GPRS support node (SGSN)). MME 108 can communicate with support node 110 to further access a core network for device 102. Moreover, for example, eNB 104 and base station 106 can each be, for example, a macrocell, femtocell, picocell, or similar base station, relay node, mobile base station, UE (e.g., communicating in peer-to-peer or ad-hoc mode with device 102), a portion thereof, and/or substantially any device that provides one or more disparate devices with access to a wireless network.

According to an example, device 102 can be camped in idle mode on eNB 104. For example, camping can refer to a communication state where device 102 receives paging signals from eNB 104, but has no active radio bearers with eNB 104. In one example, MME 108 can have one or more EPS bearers configured for device 102 in the wireless network for communicating therewith over related radio bearers when active. Camping on eNB 104, thus, can ensure device 102 is accessible for communicating when an application on the device 102 requests network data, when another device or network component requests data from device 102 through eNB 104, and/or the like. At this point, for example, device 102 can move to an active mode at least in part by activating one or more radio bearers with eNB 104 to facilitate such communicating (e.g., whether from a mobile originated request, or a mobile terminated request where a paging signal is received from eNB 104). This can include mapping the one or more activated radio bearers to one or more EPS bearers in MME 108. In this regard, camping allows for power reduction at device 102 since resources for active radio bearers can be conserved.

In one example, while camping on eNB 104, device 102 can initiate a voice call and/or receive a voice call from a different device (not shown); however, eNB 104 can be unable to handle the call (e.g., where eNB 104 lacks resources for or otherwise does not support voice over internet protocol (VoIP) or more generally IP multimedia subsystem (IMS)). In this regard, as described, device 102 can initiate a CSFB to base station 106, which can operate over a CS capable target network, to handle the call. In this example, unnecessary radio bearer activation with device 102 can be avoided during CSFB. It is to be appreciated that the unnecessary bearer activation can be avoided at the EPS network (e.g., by MME 108 or other EPS node during an ESR procedure that is part of CSFB), at the CS capable target network (e.g., by support node 110 during a relocation request with the CS capable target network), at device 102, and/or the like. As described, in this example, device 102 performed CSFB to handle the call, in this case, and thus radio bearers to facilitate communicating other data, such as Internet data, video streaming, etc. may not be necessary. Avoiding establishment of such radio bearers can conserve processing time during CSFB, as well as radio resource control (RRC) resources for establishing related radio bearers.

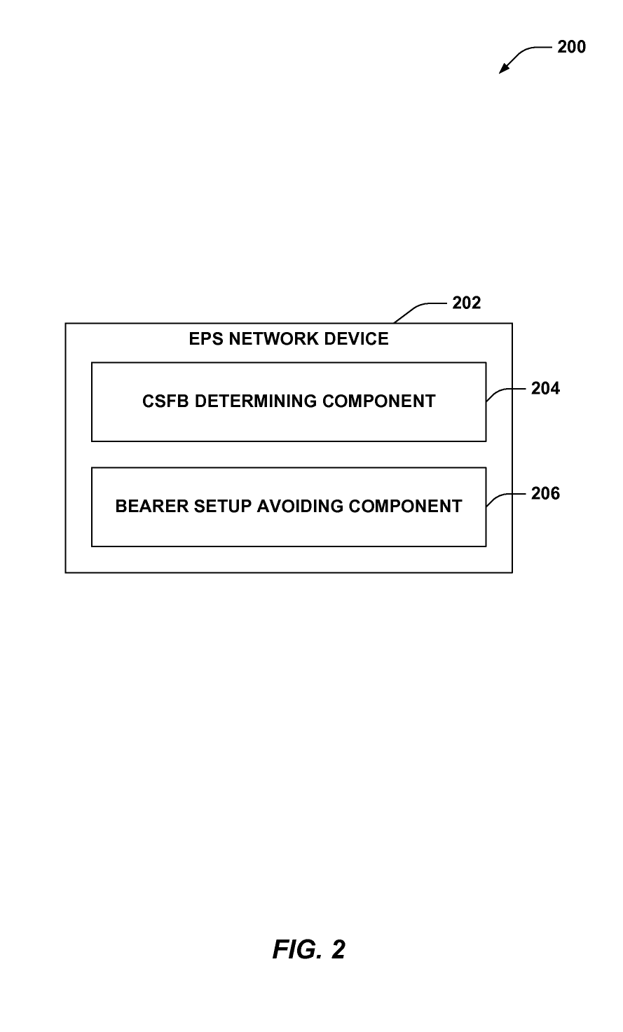

Turning to FIG. 2, illustrated is an example wireless communications system 200 that facilitates avoiding unnecessary radio bearer establishment in CSFB. System 200 comprises an EPS network device 202, which can be substantially any device that communicates in an EPS network. EPS network device 202 can include a CSFB determining component 204 that detects a CSFB procedure, and a bearer setup avoiding component 206 that mitigates establishment of unnecessary bearers during the CSFB procedure.

Thus, in one example, EPS network device 202 can be an MME that manages one or more EPS bearers for a related mobile device, as described. The mobile device can be operating in idle mode such that it does not have a radio bearer for one or more of the EPS bearers. CSFB determining component 204 can obtain an ESR from the mobile device, in this example, indicating CSFB. In this example, bearer setup avoiding component 206 can refrain from requesting bearer activation with a related eNB for the mobile device. This can include, for example, sending a null radio bearer setup list in an initial context setup request message for the mobile device to the eNB, such as a S1-application protocol (S1-AP) INITIAL CONTEXT SETUP REQUEST message in LTE. In another example, the radio bearer setup list can include one or more radio bearers for a portion of active EPS bearers where the mobile device is not in idle mode.

In an additional or alternative example, bearer setup avoiding component 206 can indicate to a core network component (not shown), such as an SGSN, not to establish radio bearers in the CS capable target network for inactive EPS bearers. For example, as part of CSFB, the core network component can refrain from establishing the radio bearers based on the indication from bearer setup avoiding component 206. In an example, bearer setup avoiding component 206 can indicate such as a parameter in a forward relocation request transmitted to the support node during CSFB. Thus, in this example, avoiding radio bearer establishment for unnecessary radio bearers can also be performed at the CS capable target network.

In yet another example, EPS network device 202 can be a UE or other mobile device that communicates with an eNB and performs CSFB to a CS capable target network. In this example, CSFB determining component 204 can specify to perform CSFB (e.g., by sending an ESR to an MME). In this example, redirection-based CSFB can be performed where communications to/for EPS network device 202 are redirected through the CS capable target network. In this example, as part of CSFB, bearer setup avoiding component 206 can refrain from initiating service request procedures to establish radio bearers for the corresponding EPS bearers (or at least a portion thereof), as opposed to initiating service request procedures for all EPS bearers related to EPS network device 202. In the above examples, unnecessary radio bearers are not established which conserves processing power and radio resources, as described.

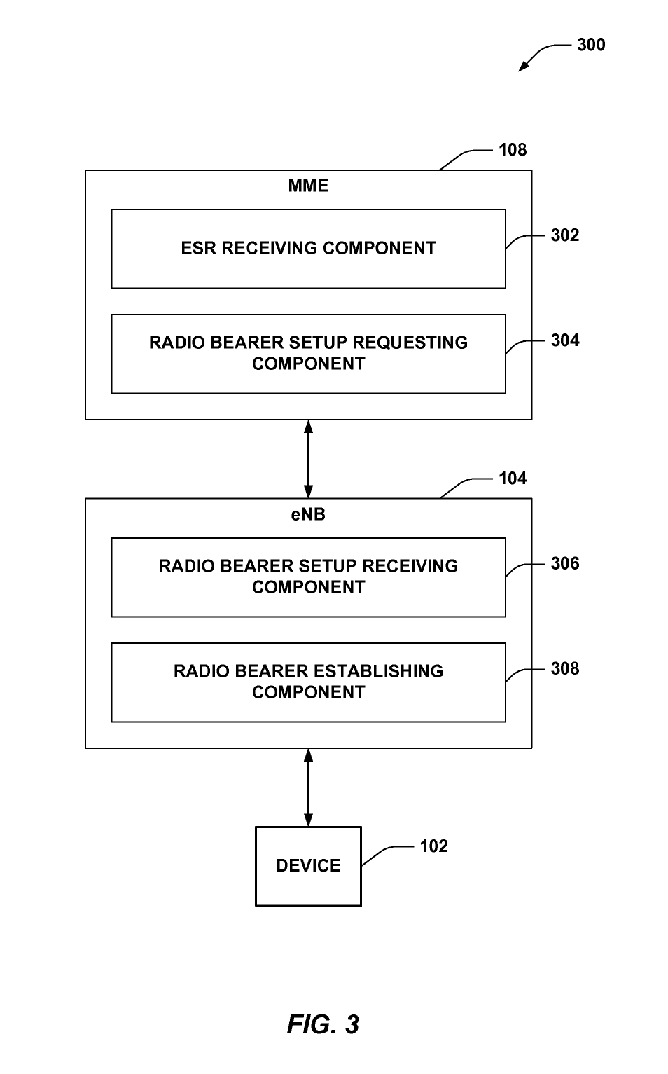

Referring to FIG. 3, illustrated is an example wireless communications system 300 that facilitates mitigating establishment of unnecessary radio bearers in CSFB. System 300 comprises a device 102, which as described can communicate with an eNB 104 to receive access to an EPS network. In addition, as described, eNB 104 can communicate with an MME 108 that manages EPS bearers for device 102. Device 102 can be camped on eNB 104 in idle mode, as described, and can initiate or receive a call. Where a call is received, as described, device 102 can be paged regarding the call. In either case, device 102 can determine to perform CSFB to handle the call over a CS capable target network. As described, for example, device 102 can perform the CSFB upon determining that an EPS of eNB 104 is inadequate for providing resources for the call (e.g., based on an indication by the eNB 104 that VoIP/IMS is not supported and/or CS networks for voice calls are preferred.

MME 108 can comprise an ESR receiving component 302 that obtains an ESR from a device (e.g., via eNB 104 and/or one or more additional eNBs or network components), and a radio bearer setup requesting component 304 that indicates zero or more DRBs for an eNB to establish with the device as part of CSFB. eNB 104 can comprise a radio bearer setup receiving component 306 that obtains a request to establish zero or more DRBs from an MME, and a radio bearer establishing component 308 that can initialize one or more DRBs with a device.

According to an example, device 102 can transmit an ESR to MME 108 to indicate CSFB, as described. ESR receiving component 302 can obtain the ESR, determining the CSFB, and radio bearer setup requesting component 304 can specify to eNB 104 to not setup any DRBs with device 102. For example, radio bearer setup requesting component 304 can transmit a null radio bearer list to eNB 104 in an S1-AP INITIAL CONTEXT SETUP REQUEST message in LTE, as described. In any case, radio bearer setup receiving component 306 can obtain the indication not to establish DRBs with device 102, and radio bearer establishing component 308 can refrain from establishing DRBs with device 102 during CSFB. In another example, radio bearer setup requesting component 304 can request setup of one or more DRBs for a portion of active EPS bearers related to device, radio bearer setup receiving component 306 can obtain the request, and radio bearer establishing component 308 can initialize the one or more DRBs, as opposed to DRBs for all EPS bearers related to device 102.

In the foregoing example, radio bearer setup receiving component 306 is able to process a null list of bearers as indicating not to setup radio bearers as part of the CSFB. In addition, MME 108 can keep the EPS bearers configured for device 102 at least for a period of time after the CSFB. In this regard, radio bearer setup requesting component 304 (and/or device 102) can subsequently request a DRB (e.g., where device 102 switches back to the EPS network following the CSFB).

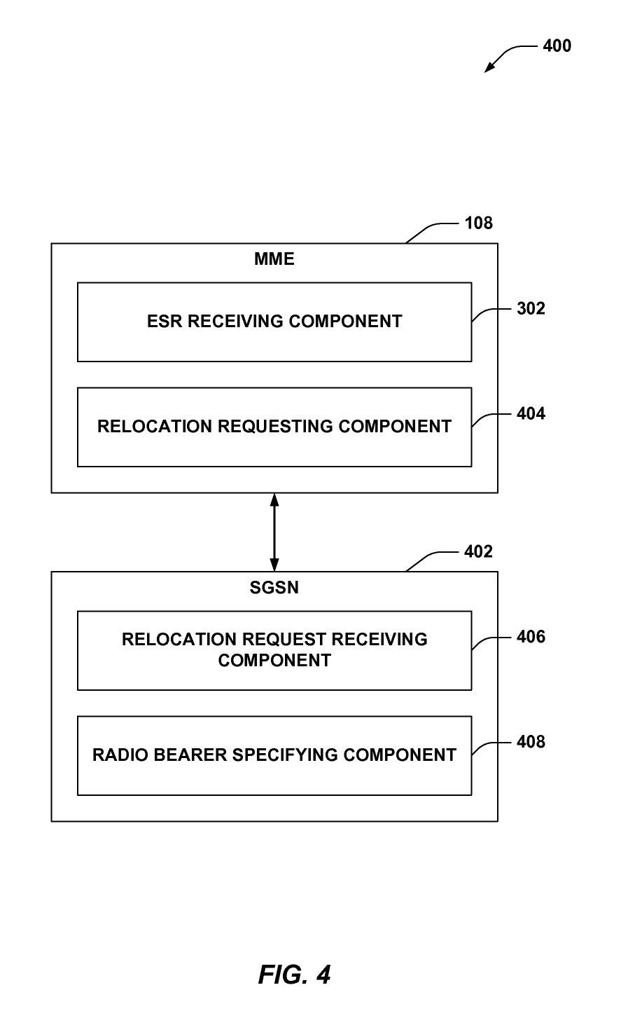

Turning to FIG. 4, illustrated is an example wireless communications system 400 that facilitates avoiding establishing unnecessary radio bearers in CSFB. System 400 comprises an MME 108 that communicates with an SGSN 402 to provide network access to one or more devices (not shown). MME 108 can comprise an ESR receiving component 302 that obtains an ESR from a device (e.g., via an eNB) for indicating CSFB of the device to a CS capable target network, as described, and a relocation requesting component 404 that facilitates communicating a context related to the MME 108 and/or device to a SGSN as part of the CSFB. SGSN 402 comprises a relocation request receiving component 406 that obtains a relocation request from an MME, and a radio bearer specifying component 408 that indicates zero or more DRBs for establishing in a CS capable target network based at least in part on the relocation request.

According to an example, ESR receiving component 302 can obtain an ESR from a device, as described, to initiate CSFB. As part of the CSFB procedure, relocation requesting component 404 can transmit a relocation request to the SGSN 402 that specifies a context of the MME 108 and/or a related device, packet data network (PDN) connections at MME 108, and/or the like. Relocation request receiving component 406 can obtain the relocation request, and radio bearer specifying component 408 can request establishment of one or more DRBs corresponding to EPS bearers at a CS capable target network (e.g., which at least supports CS domain services and can also support PS domain services).

In an example, however, relocation requesting component 404 can specify a parameter in the relocation request to indicate that DRBs should not be established for inactive EPS bearers. In this example, relocation request receiving component 406 can obtain the relocation request, and radio bearer specifying component 408 can avoid indicating one or more DRBs for establishment in the CS capable target network based at least in part on the relocation request. For example, radio bearer specifying component 408 can indicate a null or empty radio bearer setup list in transmitting a relocation request to a radio network controller (RNC) or similar component of the CS capable target network where SGSN 402 determines no EPS bearers are active for the device (e.g., where the device is in idle mode, as described). Thus, the RNC does not establish DRBs for the EPS bearers, which are not immediately necessary in view of the CSFB. In another example, where the device does have one or more active EPS bearers, radio bearer specifying component 408 can indicate radio bearers in the list for the active EPS bearers and not the inactive bearers.

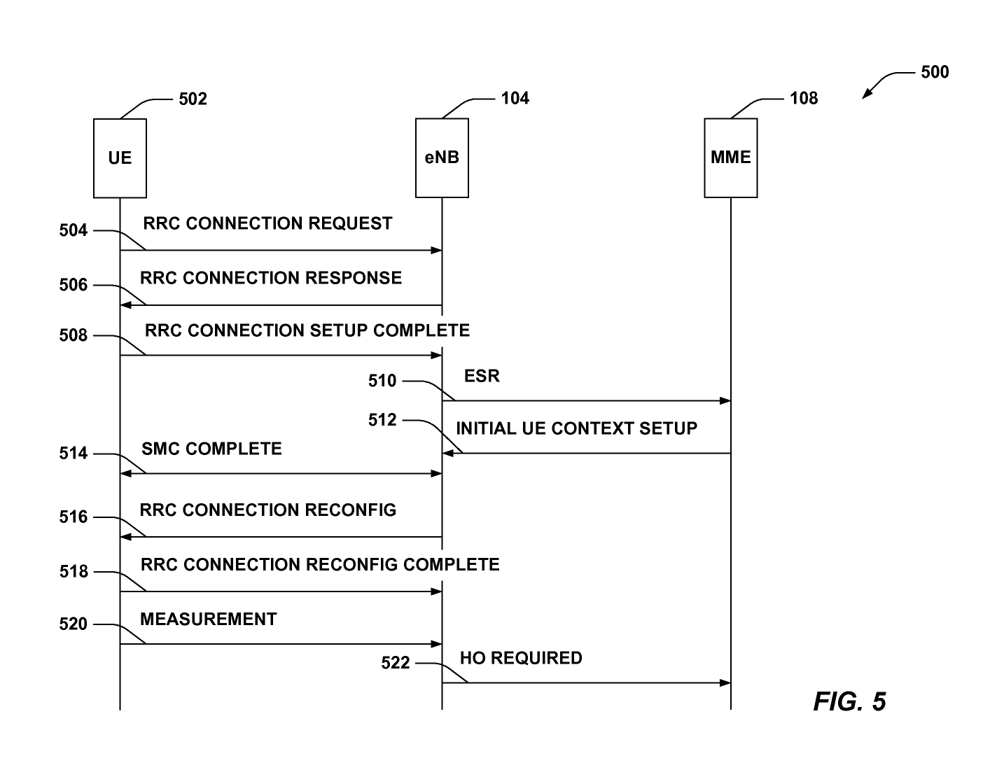

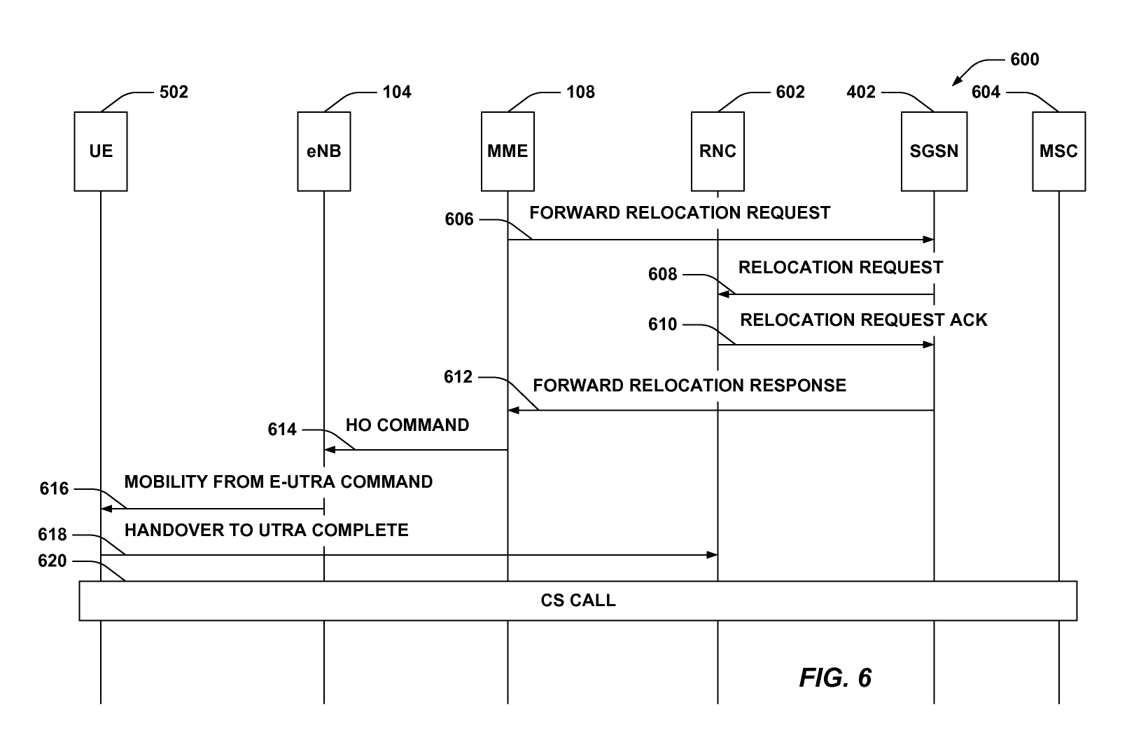

Turning to FIGS. 5-6, example wireless communication systems 500 and 600 are illustrated that facilitates performing CSFB in accordance with one or more aspects described herein. In FIG. 5, system 500 includes a UE 502 that communicates with an eNB 104, as described, to access a wireless network. eNB 104 can also communicate with an MME 108 or other network component, as described, to manage EPS bearers with UE 502. UE 502 can transmit an RRC connection request 504 to eNB 104 to establish a signaling connection (e.g., and/or one or more signaling radio bearers). eNB 104 can establish the DRB and transmit a RRC connection response 506 to UE 502. UE 502 can transmit an RRC connection setup complete 508 to eNB 104 to acknowledge establishment of the RRC connection. In one example UE 502 can include an ESR in the RRC connection setup complete 508 for forwarding to MME 108 to indicate CSFB. As described, for example, UE 502 can determine the EPS related to eNB 104 is insufficient to handle a CS voice call (e.g., based at least in part on determining resources available at eNB 104, whether the eNB 104 supports IMS/VoIP, whether CSFB is otherwise preferred for CS voice calls, and/or the like).

In this example, eNB 104 can forward the ESR 510 to MME 108. In one example, the ESR 510 indicates a CSFB request to the MME 108. MME 108 can then transmit an initial UE context setup 512 to eNB 104, which can include a CSFB indicator and zero or more DRBs to establish with UE 502. As described above, for example, MME 108 can include an empty list of DRBs in the initial UE context setup 512 so eNB 104 does not establish any DRBs with UE 502, or the list can include DRBs for a portion of EPS bearers. In either case, MME 108 can keep EPS bearers configured though an associated DRB is not established in case the EPS bearer is subsequently requested for use (e.g., MME 108 can request bearer establishment after CSFB is completed and the UE 502 has returned to the EPS). Thus, as described, processing time and radio resources need not be spent establishing unnecessary DRBs. UE 502 and eNB 104 can perform a security mode command (SMC) 514 to authenticate UE 502 with MME 108.

In this example, eNB 104 can then transmit an RRC connection reconfiguration 516 to UE 502, which can include allocated radio resources (which can be empty in one example, where eNB 104 does not establish DRBs, or have DRBs for a portion of the EPS bearers, as described). UE 502 can transmit an RRC connection reconfiguration complete 518 to eNB 104 to confirm allocated radio resource establishment. In addition, UE 502 can perform measurement 520 over surrounding cells to determine a suitable cell of a CS capable target network for handling a CS voice call. In this regard, eNB 104 can determine an optimal cell for the CS voice call. In this regard, for example, UE 502 can transmit a handover (HO) required 522 to MME 108 to initiate PS HO based CSFB procedure.

FIG. 6 shows an example wireless communication system 600 for performing PS HO. As described, system 600 can include a UE 502 that communicates with an eNB 104 to access a wireless network, and eNB 104 can also communicate with an MME 108 or other network component to manage EPS bearers with UE 502. System 600 also includes an RNC 602 of a CS capable target network, an SGSN 402 of the PS network to which MME 108 communicates, and a mobile switching center 604 (MSC) to which RNC 602 communicates to provide CS voice call functionality.

After UE 502 initiates CSFB, as shown in FIG. 5, for example, and eNB 104 sends the HO required to MME 108, a PS HO procedure can be initiated. In this example, MME 108 can transmit a forward relocation request 606 to SGSN 402 to facilitate CSFB to the CS capable target network. In an example, the forward relocation request 606 can include a context of the MME 108 and/or UE 502, which can specify not to establish DRBs for inactive EPS bearers (e.g., in a parameter or similar value of the request 606). SGSN 402 can determine whether to establish DRBs for the inactive EPS bearers based at least in part on the request 606. SGSN 402 can transmit a relocation request 608 to RNC 602 that includes a list of DRBs for establishing with UE 502. In one example, this list can be empty and/or comprise DRBs for a portion of EPS bearers, depending on the request 606 and one or more active EPS bearers.

In this example, RNC 602 can establish DRBs with UE 502 according to the DRBs in the list, or not if there are no DRBs in the list. In this regard, only necessary DRBs, if any, can be specified in the list and established to conserve processing time and radio resources, as described. RNC 602 can transmit a relocation request ACK 610 to SGSN 402 to acknowledge setup of DRBs in the list, if any. Similarly, SGSN 402 can transmit a forward relocation response 612 that indicates DRBs established by RNC 602, if any. MME 108 can then transmit an HO command 614 to eNB 104, which causes the eNB 104 to transmit a mobility from E-UTRA command 616 to UE 502. In this regard, UE 502 transmits a handover to UTRA complete 618 to RNC 602 to indicate completion of the handover to the CS capable target network. UE 502 can then perform the CS voice call 620 through RNC 602 to MSC 604. As described, for example, subsequent DRBs can be established with RNC 602 where UE 502, MME 108, etc. requests establishment for activating one or more of the EPS bearers. Avoiding setup of these bearers at CSFB, however, reduces processing time and conserves radio resources where the DRBs may not be needed, as described.

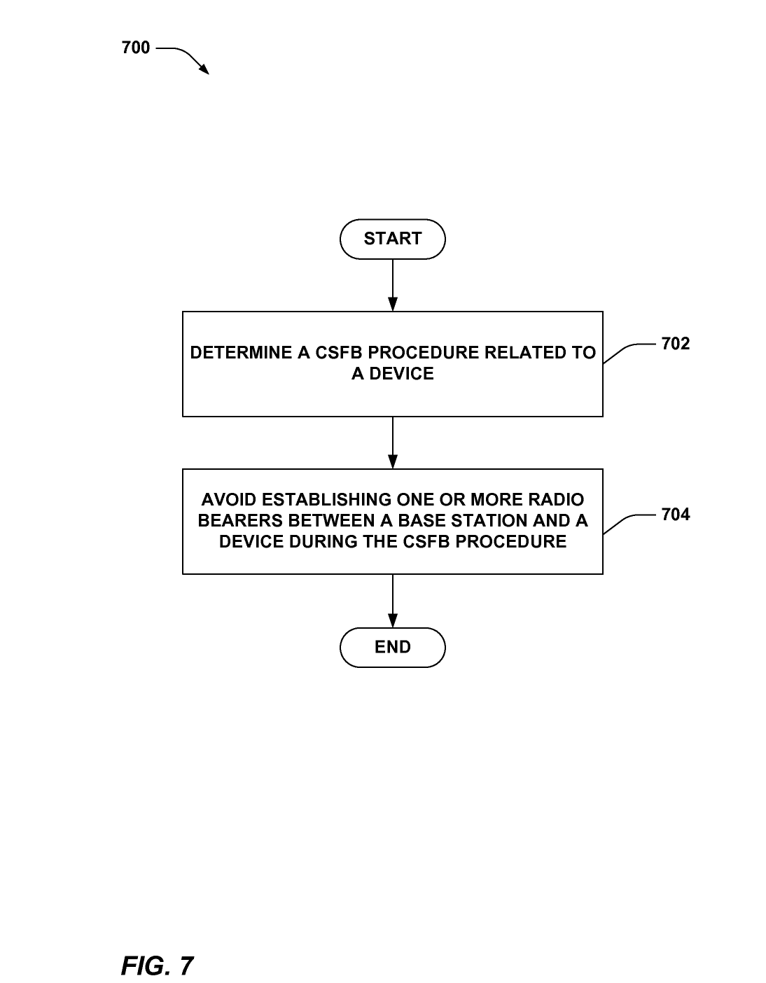

Referring to FIGS. 7-11, example methodologies relating to avoiding unnecessary radio bearer establishment in CSFB are illustrated. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

Referring to FIG. 7, an example methodology 700 is displayed that facilitates not establishing radio bearers in a CSFB procedure. At 702, a CSFB procedure related to a device can be determined. As described, for example, this can be determined based on receiving an extended service request from the device, receiving a forward relocation message from an MME, determining an EPS is insufficient to handle a call, and/or the like. At 704, establishing one or more radio bearers between a base station and a device can be avoided during the CSFB procedure. For example, this can include at least one of transmitting a radio bearer list to an eNB in an EPS network or a base station in a CS capable target network that does not include radio bearers for one or more EPS bearers (e.g., this list can be empty or null), transmitting a forward relocation request to an EPS support node that indicates not to establish radio bearers for inactive EPS bearers, not transmitting service requests to a base station in a CS capable target network for inactive EPS bearers, and/or the like, as described.

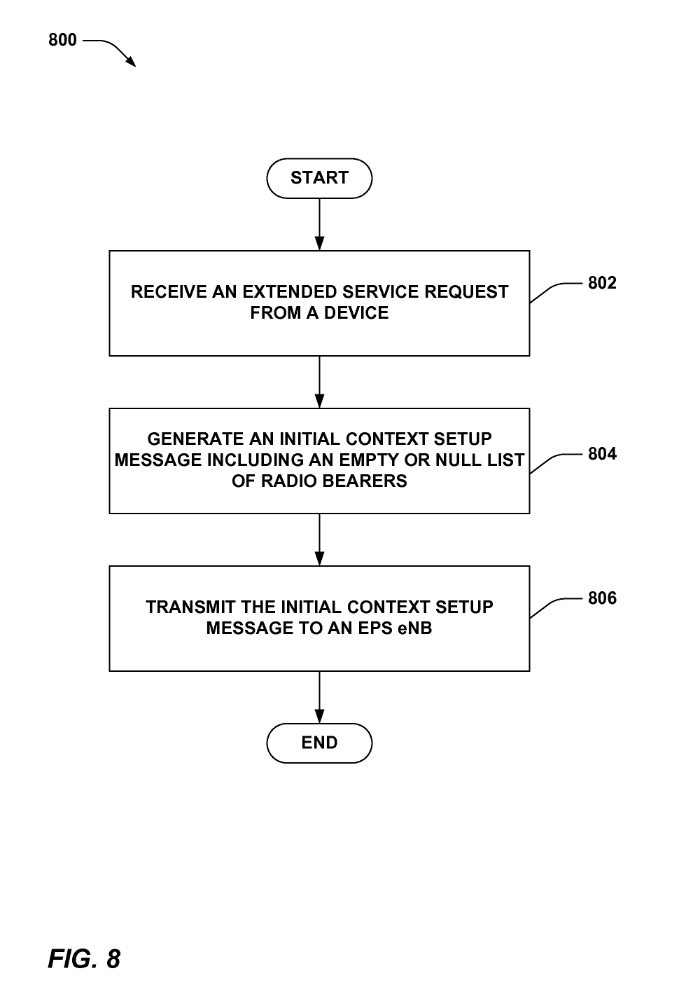

Turning to FIG. 8, an example methodology 800 is displayed that facilitates not establishing unnecessary bearers in CSFB. At 802, an extended service request can be received from a device. As described, this can initiate a CSFB. Moreover, the device can be in idle mode before CSFB such that no EPS bearers are active. At 804, an initial context setup message can be generated including an empty or null list of radio bearers. Since the device is performing CSFB and did not have other active EPS bearers, it can be unnecessary to establish radio bearers for the other EPS bearers, as described. At 806, the initial context setup message can be transmitted to an eNB. Thus, the eNB in the EPS network does not establish radio bearers since none are indicated in the list, as described. In another example, at 804, the list can include radio bearers for a portion of the EPS bearers that are active (if any are active), and thus in this example, the eNB can establish radio bearers for the active portion of EPS bearers.

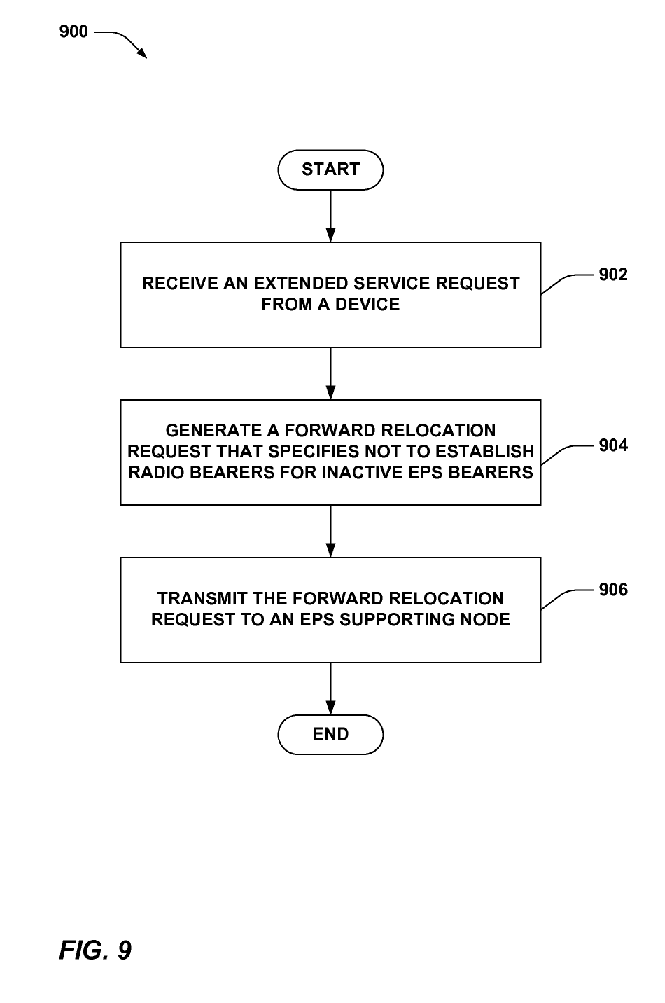

Referring to FIG. 9, illustrated is an example methodology 900 for causing an EPS support node to not establish radio bearers for inactive EPS bearers. At 902, an extended service request can be received from a device. As described, this can initiate a CSFB. At 904, a forward relocation request that specifies not to establish radio bearers for inactive EPS bearers can be generated. At 906, the forward relocation request can be transmitted to an EPS supporting node. Thus, the EPS supporting node can generate a list of radio bearers to establish at a CS capable target network, which can be an empty or null list where the device is in idle mode before CSFB, as described.

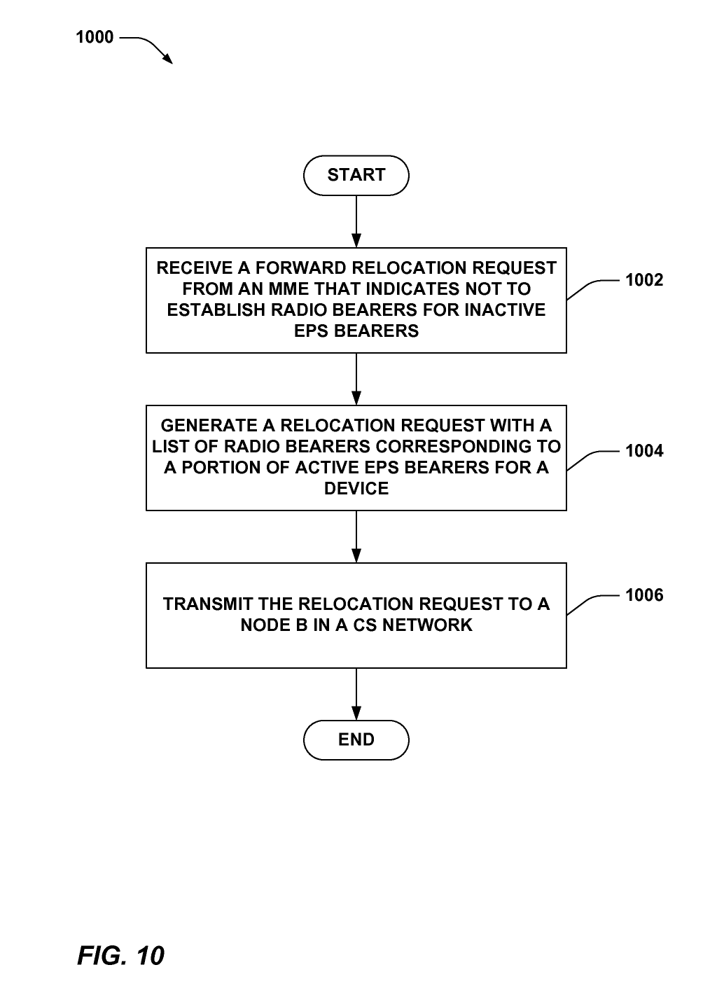

Turning to FIG. 10, an example methodology 1000 is displayed that facilitates not establishing radio bearers for inactive EPS bearers. At 1002, a forward relocation request can be received from an MME that indicates not to establish radio bearers for inactive EPS bearers. For example, the indication can be a parameter or other value in the request. At 1004, a relocation request can be generated with a list of radio bearers corresponding to a portion of active EPS bearers for a device. In one example, the device can have no active EPS bearers, in which case the list is an empty or null list. At 1006, the relocation request can be transmitted to a base station in a CS capable target network supporting CS voice calls (e.g., via an RNC). The base station can establish radio bearers with the device for the EPS bearers in the list, or no radio bearers where the list is empty or null.

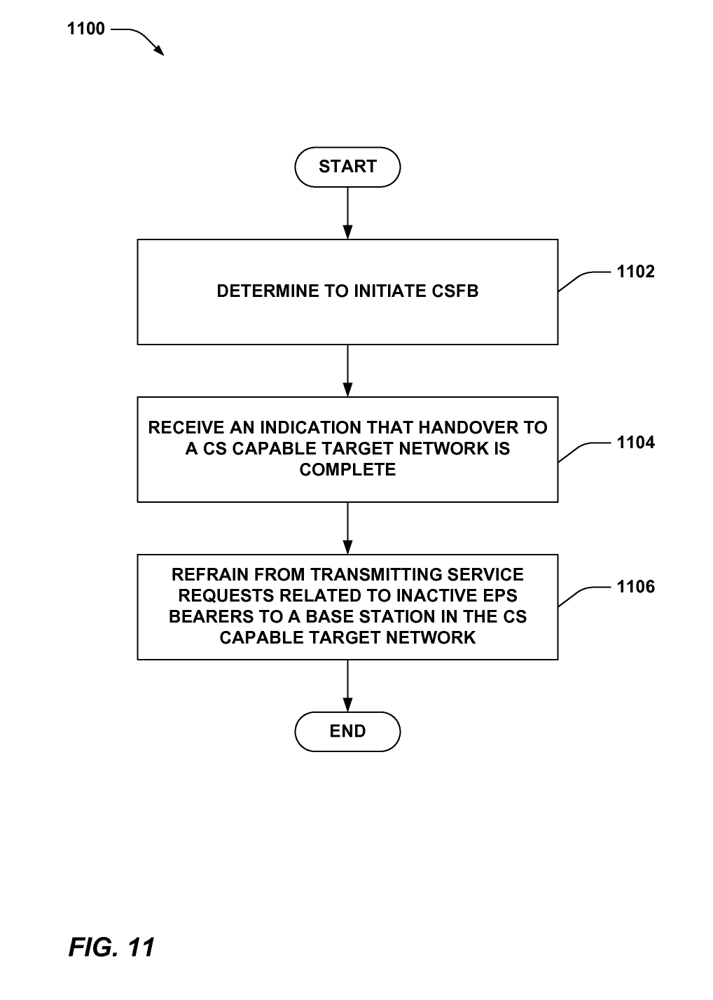

Referring to FIG. 11, illustrated is an example methodology 1100 for avoiding establishment of unnecessary radio bearers in CSFB. At 1102, it can be determined to initiate CSFB. This can be determined, for example, based at least in part on initiating and/or receiving an indication of a CS voice call, determining an EPS is insufficient to handle the CS voice call, and/or the like. At 1104, an indication that handover to a CS capable target network is complete can be received. For example, the indication can be received from a base station in the CS capable target network, from the eNB in an EPS network, and/or the like. At 1106, transmitting service requests related to inactive EPS bearers to a base station in the CS capable target network can be refrained from. Thus, unnecessary radio bearers are not established in the CS capable target network.

It will be appreciated that, in accordance with one or more aspects described herein, inferences can be made regarding determining whether to establish radio bearers in CSFB, and/or the like, as described. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

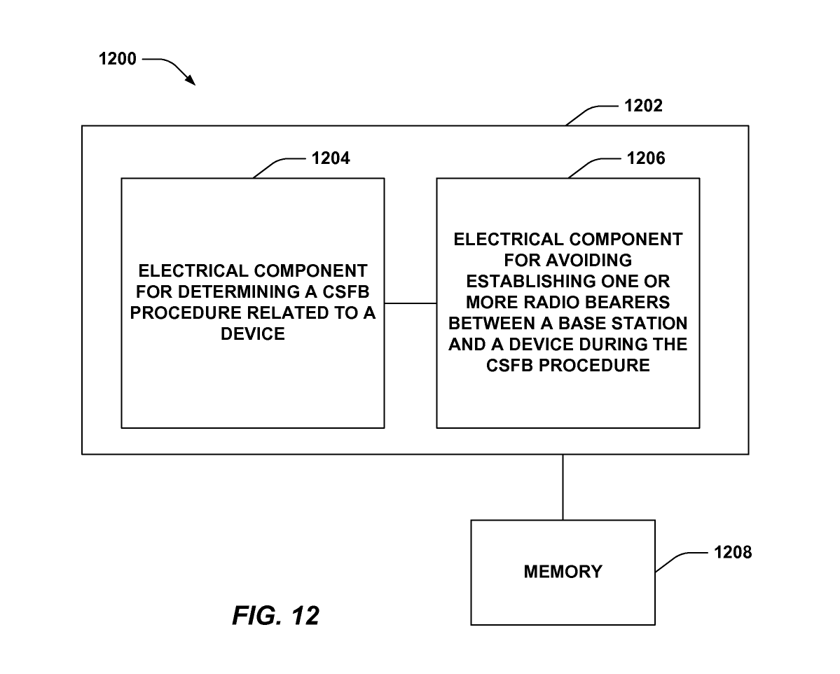

With reference to FIG. 12, illustrated is a system 1200 that avoids establishing unnecessary radio bearers during CSFB. For example, system 1200 can reside at least partially within a base station, mobile device, etc. It is to be appreciated that system 1200 is represented as including functional blocks, which can be functional blocks that represent functions implemented by a processor, software, or combination thereof (e.g., firmware). System 1200 includes a logical grouping 1202 of electrical components that can act in conjunction. For instance, logical grouping 1202 can include an electrical component for determining a CSFB procedure related to a device 1204. As described, this can include receiving an extended service request from the device, receiving a forward relocation request from an MME, determining an EPS insufficient to handle a CS voice call, and/or the like. Further, logical grouping 1202 can comprise an electrical component for avoiding establishing one or more radio bearers between a base station and a device during the CSFB procedure 1206. For example, this can include at least one of transmitting a radio bearer list to an eNB of the EPS or a base station in a CS capable target network that does not include radio bearers for one or more EPS bearers (e.g., this list can be empty or null), transmitting a forward relocation request to an EPS support node that indicates not to establish radio bearers for inactive EPS bearers, refraining from transmitting service requests to a base station in a CS capable target network for inactive EPS bearers, and/or the like, as described. Additionally, system 1200 can include a memory 1208 that retains instructions for executing functions associated with the electrical components 1204 and 1206. While shown as being external to memory 1208, it is to be understood that one or more of the electrical components 1204 and 1206 can exist within memory 1208.

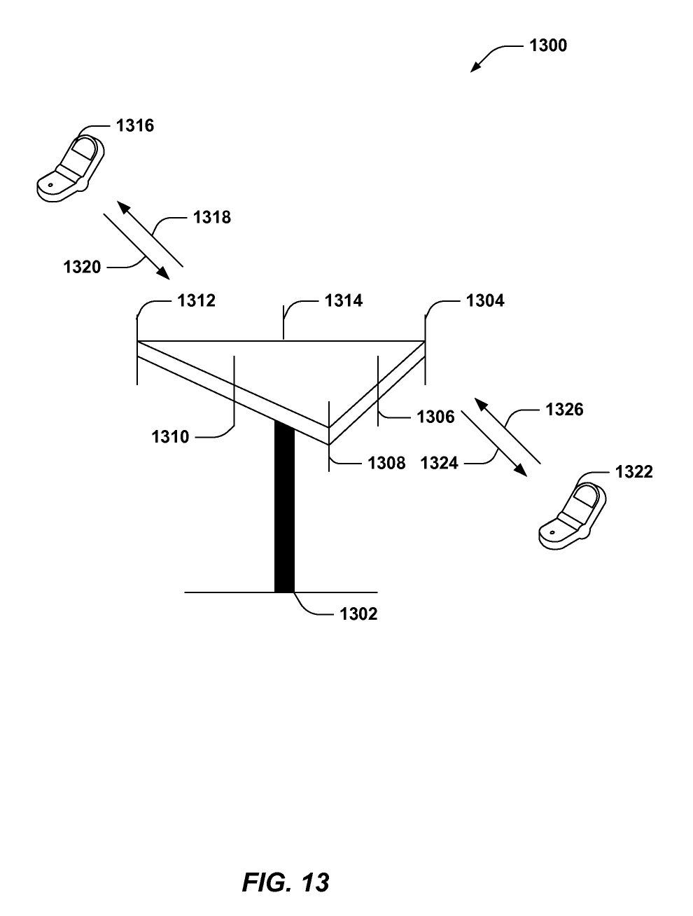

Referring now to FIG. 13, a wireless communication system 1300 is illustrated in accordance with various embodiments presented herein. System 1300 comprises a base station 1302 that can include multiple antenna groups. For example, one antenna group can include antennas 1304 and 1306, another group can comprise antennas 1308 and 1310, and an additional group can include antennas 1312 and 1314. Two antennas are illustrated for each antenna group; however, more or fewer antennas can be utilized for each group. Base station 1302 can additionally include a transmitter chain and a receiver chain, each of which can in turn comprise a plurality of components associated with signal transmission and reception (e.g., processors, modulators, multiplexers, demodulators, demultiplexers, antennas, etc.), as is appreciated.

Base station 1302 can communicate with one or more mobile devices such as mobile device 1316 and mobile device 1322; however, it is to be appreciated that base station 1302 can communicate with substantially any number of mobile devices similar to mobile devices 1316 and 1322. Mobile devices 1316 and 1322 can be, for example, cellular phones, smart phones, laptops, handheld communication devices, handheld computing devices, satellite radios, global positioning systems, PDAs, and/or any other suitable device for communicating over wireless communication system 1300. As depicted, mobile device 1316 is in communication with antennas 1312 and 1314, where antennas 1312 and 1314 transmit information to mobile device 1316 over a forward link 1318 and receive information from mobile device 1316 over a reverse link 1320. Moreover, mobile device 1322 is in communication with antennas 1304 and 1306, where antennas 1304 and 1306 transmit information to mobile device 1322 over a forward link 1324 and receive information from mobile device 1322 over a reverse link 1326. In a frequency division duplex (FDD) system, forward link 1318 can utilize a different frequency band than that used by reverse link 1320, and forward link 1324 can employ a different frequency band than that employed by reverse link 1326, for example. Further, in a time division duplex (TDD) system, forward link 1318 and reverse link 1320 can utilize a common frequency band and forward link 1324 and reverse link 1326 can utilize a common frequency band.

Each group of antennas and/or the area in which they are designated to communicate can be referred to as a sector of base station 1302. For example, antenna groups can be designed to communicate to mobile devices in a sector of the areas covered by base station 1302. In communication over forward links 1318 and 1324, the transmitting antennas of base station 1302 can utilize beamforming to improve signal-to-noise ratio of forward links 1318 and 1324 for mobile devices 1316 and 1322. Also, while base station 1302 utilizes beamforming to transmit to mobile devices 1316 and 1322 scattered randomly through an associated coverage, mobile devices in neighboring cells can be subject to less interference as compared to a base station transmitting through a single antenna to all its mobile devices. Moreover, mobile devices 1316 and 1322 can communicate directly with one another using a peer-to-peer or ad hoc technology as depicted. According to an example, system 1300 can be a multiple-input multiple-output (MIMO) communication system.

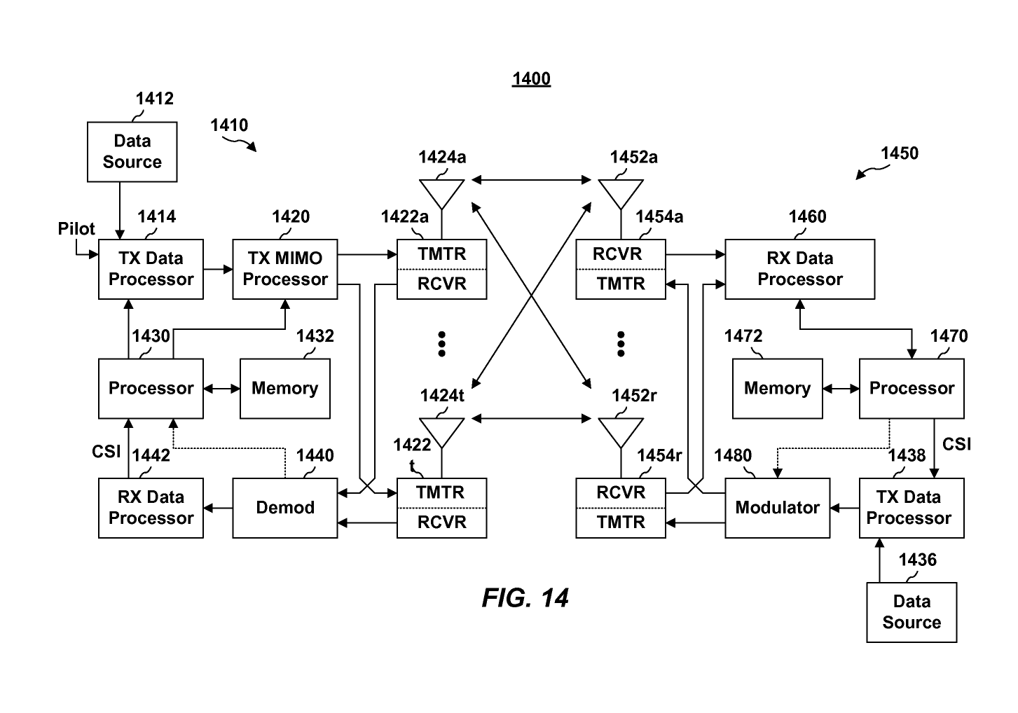

FIG. 14 shows an example wireless communication system 1400. The wireless communication system 1400 depicts one base station 1410 and one mobile device 1450 for sake of brevity. However, it is to be appreciated that system 1400 can include more than one base station and/or more than one mobile device, wherein additional base stations and/or mobile devices can be substantially similar or different from example base station 1410 and mobile device 1450 described below. In addition, it is to be appreciated that base station 1410 and/or mobile device 1450 can employ the systems (FIGS. 1-6 and 12-13) and/or methods (FIGS. 7-11) described herein to facilitate wireless communication there between. For example, components or functions of the systems and/or methods described herein can be part of a memory 1432 and/or 1472 or processors 1430 and/or 1470 described below, and/or can be executed by processors 1430 and/or 1470 to perform the disclosed functions.

At base station 1410, traffic data for a number of data streams is provided from a data source 1412 to a transmit (TX) data processor 1414. According to an example, each data stream can be transmitted over a respective antenna. TX data processor 1414 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 1450 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 1430.

The modulation symbols for the data streams can be provided to a TX MIMO processor 1420, which can further process the modulation symbols (e.g., for OFDM). TX MIMO processor 1420 then provides NT modulation symbol streams to NT transmitters (TMTR) 1422a through 1422t. In various embodiments, TX MIMO processor 1420 applies beamforming weights to the symbols of the data streams and to the antenna from which the symbol is being transmitted.

Each transmitter 1422 receives and processes a respective symbol stream to provide one or more analog signals, and further conditions (e.g., amplifies, filters, and upconverts) the analog signals to provide a modulated signal suitable for transmission over the MIMO channel. Further, NT modulated signals from transmitters 1422a through 1422t are transmitted from NT antennas 1424a through 1424t, respectively.

At mobile device 1450, the transmitted modulated signals are received by NR antennas 1452a through 1452r and the received signal from each antenna 1452 is provided to a respective receiver (RCVR) 1454a through 1454r. Each receiver 1454 conditions (e.g., filters, amplifies, and downconverts) a respective signal, digitizes the conditioned signal to provide samples, and further processes the samples to provide a corresponding “received” symbol stream.

An RX data processor 1460 can receive and process the NR received symbol streams from NR receivers 1454 based on a particular receiver processing technique to provide NT “detected” symbol streams. RX data processor 1460 can demodulate, deinterleave, and decode each detected symbol stream to recover the traffic data for the data stream. The processing by RX data processor 1460 is complementary to that performed by TX MIMO processor 1420 and TX data processor 1414 at base station 1410.

A processor 1470 can periodically determine which precoding matrix to utilize as discussed above. Further, processor 1470 can formulate a reverse link message comprising a matrix index portion and a rank value portion.

The reverse link message can comprise various types of information regarding the communication link and/or the received data stream. The reverse link message can be processed by a TX data processor 1438, which also receives traffic data for a number of data streams from a data source 1436, modulated by a modulator 1480, conditioned by transmitters 1454a through 1454r, and transmitted back to base station 1410.

At base station 1410, the modulated signals from mobile device 1450 are received by antennas 1424, conditioned by receivers 1422, demodulated by a demodulator 1440, and processed by a RX data processor 1442 to extract the reverse link message transmitted by mobile device 1450. Further, processor 1430 can process the extracted message to determine which precoding matrix to use for determining the beamforming weights.

Processors 1430 and 1470 can direct (e.g., control, coordinate, manage, etc.) operation at base station 1410 and mobile device 1450, respectively. Respective processors 1430 and 1470 can be associated with memory 1432 and 1472 that store program codes and data. Processors 1430 and 1470 can also perform computations to derive frequency and impulse response estimates for the uplink and downlink, respectively.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method of wireless communication, comprising:
determining a circuit switched fallback (CSFB) procedure related to a device; and
avoiding establishing one or more radio bearers between a base station and a device during the CSFB procedure.

2. The method of claim 1, wherein the avoiding establishing the one or more radio bearers comprises indicating a list of radio bearers in an initial context setup message to the base station that excludes radio bearers for one or more EPS bearers.

3. The method of claim 2, wherein the indicating the list of radio bearers comprises indicating a null or empty list of radio bearers in the initial context setup message.

4. The method of claim 2, further comprising keeping the one or more EPS bearers active for at least a period of time following the CSFB procedure.

5. The method of claim 1, wherein the avoiding establishing the one or more radio bearers comprises transmitting a forward relocation request to a serving general packet radio service (GPRS) serving support node that indicates to not establish radio bearers for one or more evolved packet system bearers.

6. The method of claim 1, wherein the determining the CSFB procedure includes receiving an extended service request from the device.

7. The method of claim 1, wherein the avoiding establishing the one or more radio bearers comprises refraining from transmitting a service request for the one or more radio bearers to the base station, wherein the base station is in a circuit switched capable target network selected as part of the CSFB procedure.

8. The method of claim 7, wherein the determining the CSFB procedure is based at least in part on initiating or receiving an indication of a call from another device.

9. The method of claim 1, wherein the determining the CSFB procedure is based at least in part on receiving a forward relocation request from a mobility management entity that indicates to avoid establishment of radio bearers for inactive evolved packet system (EPS) bearers, and the avoiding establishing the one or more radio bearers comprises providing a list of radio bearers to a circuit switched capable target network that excludes radio bearers for one or more EPS bearers.

10. The method of claim 9, wherein the providing the list of radio bearers comprises providing a null or empty list of radio bearers to the circuit switched capable target network.

11. An apparatus for performing circuit switched fallback (CSFB), comprising:
at least one processor configured to:
detect a CSFB procedure related to a device; and
determine to avoid establishment of one or more radio bearers between a base station and a device during the CSFB procedure; and
a memory coupled to the at least one processor.

12. The apparatus of claim 11, wherein the at least one processor is further configured to provide a list of radio bearers in an initial context setup message to the base station that excludes radio bearers for one or more evolved packet system bearers based at least in part on determining to avoid establishment of one or more radio bearers.

13. The apparatus of claim 12, wherein the list of radio bearers is an empty or null list.

14. The apparatus of claim 11, wherein the at least one processor is further configured to transmit a forward relocation request to a serving general packet radio service (GPRS) serving support node that indicates to not establish radio bearers for inactive evolved packet system bearers based at least in part on determining to avoid establishment of one or more radio bearers.

15. The apparatus of claim 11, wherein the at least one processor detects the CSFB procedure at least in part by receiving an extended service request from the device.

16. The apparatus of claim 11, wherein the at least one processor is further configured to refrain from transmitting a service request for the one or more radio bearers to the base station based at least in part on determining to avoid establishment of one or more radio bearers, and the base station is in a circuit switched capable target network.

17. The apparatus of claim 16, wherein the at least one processor detects the CSFB procedure at least in part by determining that an evolved packet system network is insufficient to handle a call.

18. The apparatus of claim 11, wherein the at least one processor detects the CSFB procedure based at least in part on receiving a forward relocation request from a mobility management entity that indicates to avoid establishment of radio bearers for inactive evolved packet system (EPS) bearers, and the at least one processor determines to avoid establishment of one or more radio bearers based at least in part on the forward relocation request.

19. The apparatus of claim 18, wherein the at least one processor is further configured to provide a list of radio bearers excluding radio bearers for one or more EPS bearers to the base station in a circuit switched capable target network based at least in part on determining to avoid establishment of one or more radio bearers.

20. The apparatus of claim 19, wherein the list of radio bearers is an empty or null list.

21. An apparatus for performing circuit switched fallback (CSFB), comprising:
means for determining a CSFB procedure related to a device; and
means for avoiding establishing one or more radio bearers between a base station and a device as part of the CSFB procedure.

22. The apparatus of claim 21, wherein the means for avoiding indicates a list of radio bearers in an initial context setup message to the base station that excludes radio bearers for one or more evolved packet system bearers.

23. The apparatus of claim 22, wherein the list of radio bearers is an empty or null list.

24. The apparatus of claim 21, wherein the means for avoiding transmits a forward relocation request to a serving general packet radio service (GPRS) serving support node that indicates not to establish radio bearers for inactive evolved packet system bearers.

25. The apparatus of claim 21, wherein the means for determining determines the CSFB procedure based at least in part on receiving an extended service request from the device.

26. The apparatus of claim 21, wherein the means for avoiding refrains from transmitting a service request for the one or more radio bearers to the base station during the CSFB procedure, and the base station is in a circuit switched capable target network.

27. The apparatus of claim 26, wherein the means for determining determines the CSFB procedure based at least in part on initiating or receiving an indication of a circuit switched voice call.

28. The apparatus of claim 21, wherein the means for determining determines the CSFB procedure based at least in part on receiving a forward relocation request from a mobility management entity that indicates to avoid establishment of radio bearers for inactive evolved packet system (EPS) bearers, and the means for avoiding provides a list of radio bearers to the base station in a circuit switched capable target network that excludes radio bearers for one or more EPS bearers related to the device.

29. The apparatus of claim 28, wherein the list of radio bearers is an empty or null list.

30. A computer program product for performing circuit switched fallback (CSFB), comprising:
a computer-readable medium, comprising:
code for causing at least one computer to detect a CSFB procedure related to a device; and
code for causing the at least one computer to determine to avoid establishment of one or more radio bearers between a base station and a device during the CSFB procedure.

31. The computer program product of claim 30, wherein the computer-readable medium further comprises code for causing the at least one computer to provide a list of radio bearers in an initial context setup message to the base station that excludes radio bearers for one or more evolved packet system bearers based at least in part on the code for causing the at least one computer to determine determining to avoid establishment of one or more radio bearers.

32. The computer program product of claim 31, wherein the list of radio bearers is an empty or null list.

33. The computer program product of claim 30, wherein the computer-readable medium further comprises code for causing the at least one computer to transmit a forward relocation request to a serving general packet radio service (GPRS) serving support node that indicates to not establish radio bearers for inactive evolved packet system bearers based at least in part on the code for causing the at least one computer to determine determining to avoid establishment of one or more radio bearers.

34. The computer program product of claim 30, wherein the code for causing the at least one computer to detect detects the CSFB procedure at least in part by receiving an extended service request from the device.

35. The computer program product of claim 30, wherein the computer-readable medium further comprises code for causing the at least one computer to refrain from transmitting a service request for the one or more radio bearers to the base station based at least in part on the code for causing the at least one computer to determine determining to avoid establishment of one or more radio bearers, and the base station is in a circuit switched capable target network .

36. The computer program product of claim 35, wherein the code for causing the at least one computer to detect detects the CSFB procedure at least in part by determining that an evolved packet system network is insufficient to handle a call.

37. The computer program product of claim 30, wherein the code for causing the at least one computer to detect detects the CSFB procedure based at least in part on receiving a forward relocation request from a mobility management entity that indicates to avoid establishment of radio bearers for inactive evolved packet system (EPS) bearers, and the code for causing the at least one computer to determine determines to avoid establishment of one or more radio bearers based at least in part on the forward relocation request.

38. The computer program product of claim 37, wherein the computer-readable medium further comprises code for causing the at least one computer to provide a list of radio bearers excluding radio bearers for one or more EPS bearers to the base station in a circuit switched capable target network based at least in part on the code for causing the at least one computer to determine determining to avoid establishment of one or more radio bearers.

39. The computer program product of claim 38, wherein the list of radio bearers is an empty or null list.

40. An apparatus for performing circuit switched fallback (CSFB), comprising:
a CSFB determining component for detecting a CSFB procedure related to a device; and
a bearer setup avoiding component for avoiding establishing one or more radio bearers between a base station and a device as part of the CSFB procedure.

41. The apparatus of claim 40, wherein the bearer setup avoiding component indicates a list of radio bearers in an initial context setup message to the base station that excludes radio bearers for one or more evolved packet system bearers.

42. The apparatus of claim 41, wherein the list of radio bearers is an empty or null list.

43. The apparatus of claim 40, wherein the bearer setup avoiding component transmits a forward relocation request to a serving general packet radio service (GPRS) serving support node that indicates not to establish radio bearers for inactive evolved packet system bearers.

44. The apparatus of claim 40, wherein the CSFB determining component determines the CSFB procedure based at least in part on receiving an extended service request from the device.

45. The apparatus of claim 40, wherein the bearer setup avoiding component refrains from transmitting a service request for the one or more radio bearers to the base station during the CSFB procedure, and the base station is in a circuit switched network.

46. The apparatus of claim 45, wherein the CSFB determining component determines the CSFB procedure based at least in part on initiating or receiving an indication of a circuit switched voice call.

47. The apparatus of claim 40, wherein the CSFB determining component determines the CSFB procedure based at least in part on receiving a forward relocation request from a mobility management entity that indicates to avoid establishment of radio bearers for inactive evolved packet system (EPS) bearers, and the bearer setup avoiding component provides a list of radio bearers to the base station in a circuit switched capable target network that excludes radio bearers for one or more EPS bearers related to the device.

48. The apparatus of claim 47, wherein the list of radio bearers is an empty or null list.
